(19) United States
(12) Patent Application Publication
(10) Pub. No.: US 2020/0392764 A1
(43) Pub. Date: Dec. 17, 2020

(54) METHOD OF LOCKING THE DOORS OF A VEHICLE

(71) Applicant: GM GLOBAL TECHNOLOGY OPERATIONS LLC, Detroit, MI (US)

(72) Inventors: Jeffrey L. Konchan, Romeo, MI (US); Frank J. Arabia, Macomb, MI (US)

(73) Assignee: GM GLOBAL TECHNOLOGY OPERATIONS LLC, Detroit, MI (US)

(21) Appl. No.: 16/443,331

(22) Filed: Jun. 17, 2019

(51) Int. Cl. E05B 77/04; E05B 77/48; E05B 81/58; E05B 77/54; E05B 77/06; B60R 21/0136; G07C 5/08; B60R 25/20

(52) U.S. Cl. CPC E05B 77/04; E05B 77/48; E05B 81/58; E05B 77/54; E05Y 2900/531; B60R 21/0136; G07C 5/0808; B60R 25/20; E05B 77/06

(57) ABSTRACT

A method of locking a plurality of doors of a vehicle includes sensing a deceleration event with an accelerometer of the vehicle in which a deceleration of the vehicle is greater than or equal to a threshold deceleration. After sensing, the method includes deploying a supplementary inflatable restraint of the vehicle and, substantially concurrent to deploying, locking each of the plurality of doors.

### INTRODUCTION

The disclosure relates to a method of locking a plurality of doors of a vehicle.

A vehicle door generally includes a door latch that secures the door to a body of the vehicle, and a door lock system that locks the door latch and prevents the door from being opened from an environment exterior to the vehicle. The door may be opened from an interior of the vehicle by operating an interior door handle.

### SUMMARY

A method of locking a plurality of doors of a vehicle includes sensing a deceleration event with an accelerometer of the vehicle in which a deceleration of the vehicle is greater than or equal to a threshold deceleration. After sensing, the method includes deploying a supplementary inflatable restraint of the vehicle. The method also includes, substantially concurrent to deploying, locking each of the plurality of doors.

In one aspect, the method may further include, after locking, automatically generating a control signal to unlock each of the plurality of doors.

In another aspect, automatically generating may occur at from 10 seconds to 20 seconds after locking.

In a further aspect, the method may also include sensing contact between the vehicle and an object external to the vehicle with a sensing device of the vehicle.

In yet another aspect, the method may further include ensuring that actuation of an interior door handle of the vehicle does not unlatch a respective one of the plurality of doors. The method may also include uncoupling an inertia of a door handle of the vehicle from a latch of one of the plurality of doors.

In one aspect, the method may further include, prior to deploying, unlocking at least one of the plurality of doors.

In another aspect, the method may include, prior to deploying, locking at least one of the plurality of doors.

In one aspect, locking may include immediately transitioning each of the plurality of doors from an unlocked state in which actuation of an exterior door handle of the vehicle opens one of the plurality of doors to a locked state in which actuation of the exterior door handle does not open one of the plurality of doors.

In another aspect, locking may include preventing each of the plurality of doors from transitioning to the unlocked state.

In a further aspect, deploying may include sending a signal from at least one of the accelerometer and the sensing device to a sensing diagnostic module of the vehicle disposed in electrical communication with the supplementary inflatable restraint.

In yet another aspect, deploying may include sending a deployment signal from the sending diagnostic module to a body control module of the vehicle disposed in electrical communication with an interior door handle of the vehicle.

In an additional aspect, locking may include sending a door lock command signal from the body control module to a vehicle lock controller.

In one aspect, locking may include actuating a plurality of door lock actuators each disposed in communication with a respective one of the plurality of doors.

A method of locking a plurality of doors of a vehicle includes sensing a deceleration event with an accelerometer of the vehicle in which a deceleration of the vehicle is greater than or equal to a threshold deceleration. The method also includes, after sensing, deploying a supplementary inflatable restraint of the vehicle. The method further includes, prior to sensing, unlocking at least one of the plurality of doors. Substantially concurrent to deploying, the method includes locking each of the plurality of doors. After locking, the method includes automatically generating a control signal to unlock each of the plurality of doors at from 10 seconds to 20 seconds after deploying.

In one aspect, locking may include immediately transitioning at least one of the plurality of doors from an unlocked state in which actuation of an exterior door handle of the vehicle opens one of the plurality of doors to a locked state in which actuation of the exterior door handle does not open one of the plurality of doors.

In another aspect, locking may include preventing each of the plurality of doors from transitioning to the unlocked state.

In a further aspect, the method may also include ensuring that actuation of an interior door handle of the vehicle does not unlatch a respective one of the plurality of doors.

In yet another aspect, deploying may include sending a deployment signal from a sensing diagnostic module of the vehicle to a body control module of the vehicle disposed in electrical communication with the interior door handle.

In an additional aspect, locking may include sending a door lock command signal from the body control module to a vehicle lock controller.

The above features and advantages and other features and advantages of the present disclosure will be readily apparent from the following detailed description of the preferred embodiments and best modes for carrying out the present disclosure when taken in connection with the accompanying drawings and appended claims.

### BRIEF DESCRIPTION OF THE DRAWINGS

FIG. 1 is a schematic illustration of a plan, partially cutaway view of a vehicle.

FIG. 2 is a flowchart of a method of locking a plurality of doors of the vehicle of FIG. 1.

### DETAILED DESCRIPTION

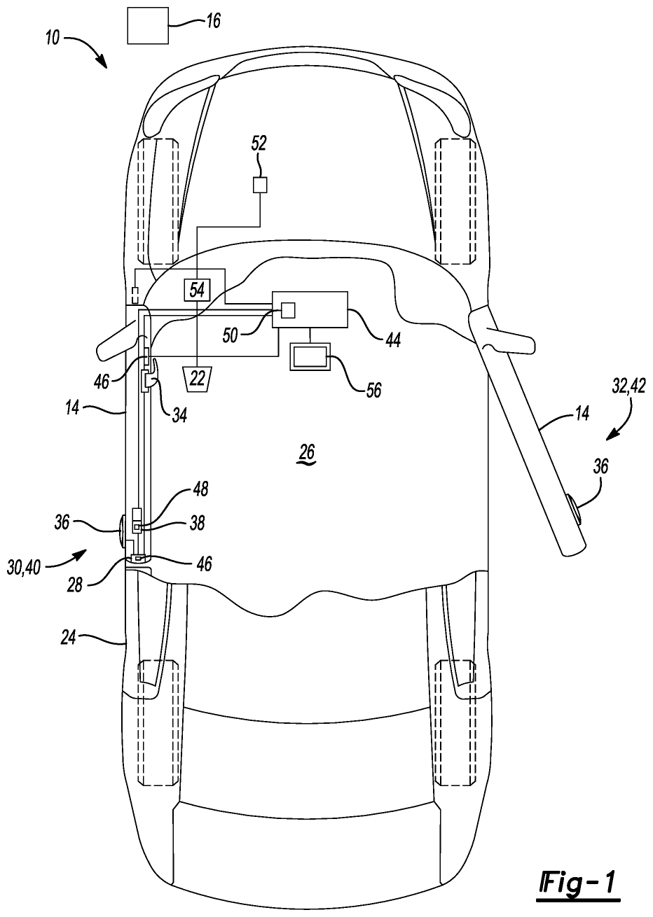

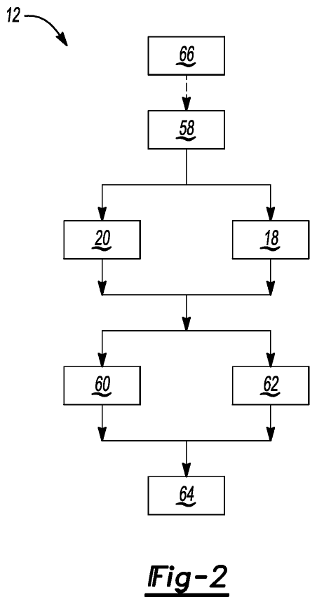

Referring to the Figures, wherein like reference numerals refer to like elements, a vehicle 10 and a method 12 of locking a plurality of doors 14 of the vehicle 10 are shown generally in FIGS. 1 and 2. The vehicle 10 and method 12 may be useful for enhancing occupant comfort and security during a deceleration event in which a deceleration of the vehicle 10 is greater than or equal to a threshold deceleration. That is, the vehicle 10 and method 12 may ensure that unintended door handle actuations during the deceleration event that are caused by, for example, inertia, vehicle deformation, and/or vehicle contact with an object 16 external to the vehicle 10 do not cause the plurality of doors 14 to unlatch and/or open. In particular, as set forth in more detail below, the method 12 includes locking 18 (FIG. 2) each of the plurality of doors 14 substantially concurrent to deploying 20 (FIG. 2) a supplementary inflatable restraint 22 (FIG. 1) of the vehicle 10. As such, the vehicle 10 and method 12 may ensure that the plurality of doors 14 are locked during and after the deceleration event to thereby maximize occupant security. Therefore, the vehicle 10 and method 12 may be useful for automotive vehicles such as a passenger car, sport utility vehicle, or truck. Alternatively, the vehicle 10 and method 12 may be useful for another vehicle type, such as, but not limited to, an industrial vehicle, a recreational off-road vehicle, a train, a semi-trailer, and the like.

Certain terminology may be used in the following description for the purpose of reference, and is not intended to be limiting. For example, terms such as “above” and “below” refer to directions in the referenced Figures. Terms such as “front,” “back,” “left,” “right,” “rear,” and “side” describe an orientation and/or location of a portion or portions of the components or elements of the vehicle 10 within a consistent but arbitrary frame of reference as set forth by the text and the associated Figures. Moreover, terms such as “first,” “second,” “third,” and so on may be used to describe separate components. Such terminology may include the words specifically mentioned above, derivatives thereof, and similar words.

Referring again to FIG. 1, the vehicle 10 may include a body 24 and the plurality of doors 14 each configured to provide ingress and egress into and out of an interior passenger compartment 26 defined by the vehicle 10. Each of the plurality of doors 14 may include a latch 28 that is operable to secure the plurality of doors 14 relative to the body 24 to prevent the plurality of doors 14 from moving out of a closed position 30. When the latch 28 is engaged and the plurality of doors 14 are secured by the latch 28, the plurality of doors 14 may be secured relative to the body 24 in the closed position 30. When the latch 28 is disengaged, i.e., when the plurality of doors 14 are unlatched, the plurality of doors 14 may be free to move between the closed position 30 and an open position 32. The latch 28 may include a suitable style and/or configuration of latch 28. For example, the latch 28 may include a fork bolt (not shown) supported by the door 14 that is rotatable to engage a striker (not shown) that is supported by the body 24. Further, the latch 28 may be actuated by either an interior door handle 34 or an exterior door handle 36.

As described with continued reference to FIG. 1, the vehicle 10 may further include a door lock system 38 configured to control and lock each of the plurality of doors 14. The door lock system 38 may be operable to lock the latch 28 of each of the plurality of doors 14 to prevent the latch 28 from being moved from an engaged position into a disengaged position. The door lock system 38 may include a suitable style and/or configuration of lock capable of locking the latch 28 for each of the plurality of doors 14. Further, the door lock system 38 may be moveable between a locked state 40, in which actuation of the exterior door handle 36 does not open one of the plurality of doors 14, and an unlocked state 42 in which actuation of the exterior door handle 36 opens one of the plurality of doors 14. When disposed in the locked state 40, the door lock system 38 may lock each latch 28 and may prevent each latch 28 from being disengaged. When disposed in the unlocked state 42, the door lock system 38 may not interfere with each latch 28 and may allow each latch 28 to be manipulated between the engaged state and the disengaged state.

Referring again to FIG. 1, the vehicle 10 may also include a vehicle lock controller 44 that is configured to control the door lock system 38. For example, the vehicle lock controller 44 may send a control signal when signaled by a remote keyless entry device. Alternatively, the vehicle lock controller 44 may send the control signal to inactivate the door lock system 38 in response to satisfaction of one or more sensed and/or determined vehicle conditions, such as, for example and without limitation, the deceleration event, contact between the vehicle 10 and the object 16 external to the vehicle 10, and/or movement of the interior door handle 34.

As described with continued reference to FIG. 1, the vehicle 10 may further include a lock switch 46 coupled to the door lock system 38. The lock switch 46 may be operable to sense a status of the door lock system 38, i.e., the locked state 40 or the unlocked state 42, and move or transition the door lock system 38 between the locked state 40 and the unlocked state 42. The lock switch 46 may include a type and/or style of switch suitable for use with the door lock system 38 and may be capable of transitioning the door lock system 38 between the locked state 40 and the unlocked state 42. Further, the lock switch 46 may be in electronic communication with the vehicle lock controller 44. That is, the vehicle lock controller 44 may be operable to send and receive control signals to and from the lock switch 46 to determine and control the status of the door lock system 38.

In addition, the door lock system 38 and vehicle 10 may further include a plurality of door lock actuators 48 each disposed in communication with a respective one of the plurality of doors 14. Each door lock actuator 48 may be configured to physically lock and unlock the respective one of the plurality of doors 14 and may include, for example and without limitation, an electric motor, one or more gears, one or more linkages, and/or a cable that may extend or retract to thereby operate the lock. The plurality of door lock actuators 48 may be monitored by the vehicle lock controller 44.

The vehicle lock controller 44 may be operable to control the door lock system 38. The vehicle lock controller 44 may include a computer and/or processor, and include software, hardware, memory, algorithms, connections, sensors, etc., to manage and control the operation of the door lock system 38. As such, the method 12 described below and generally shown in FIG. 2 may be embodied as a program operable on the vehicle lock controller 44. It should be appreciated that the vehicle lock controller 44 may include a device capable of analyzing data from various sensors and/or switches 46, comparing data, making decisions required to control the operation of the door lock system 38, and executing required tasks to control the operation of the door lock system 38.

The vehicle lock controller 44 may include a tangible non-transitory memory having computer executable instructions recorded thereon that may include a lock control module (not illustrated). The vehicle lock controller 44 may further include a processor that is operable to execute the lock control module to perform one or more actions of the method 12 described below. The lock control module may use data from the door lock system 38, sensor(s), and/or switch(es) 46 of the vehicle 10 to determine whether the deceleration event is occurring or imminent.

More specifically, the vehicle lock controller 44 may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and required input/output (I/O) circuitry, I/O devices, and communication interfaces, as well as signal conditioning and buffer electronics.

The computer-readable memory may include non-transitory/tangible medium which may participate in providing data or computer-readable instructions. Memory may be non-volatile or volatile. Non-volatile media may include, for example, optical or magnetic disks and other persistent memory. Example volatile media may include dynamic random access memory (DRAM), which may constitute a main memory. Other examples of embodiments for memory include a floppy, flexible disk, or hard disk, magnetic tape or other magnetic medium, a CD-ROM, DVD, and/or other optical medium, as well as other possible memory devices such as flash memory.

Referring again to FIG. 1, the vehicle 10 may include an accelerometer 50 that may be operable to sense, measure, or detect acceleration and deceleration of the vehicle 10. That is, the accelerometer 50 may be operable to detect the deceleration event in which a deceleration of the vehicle 10 is greater than or equal to a threshold deceleration. Stated differently, the accelerometer 50 may be configured to sense when the vehicle 10 is decelerating too rapidly. The accelerometer 50 may be a suitable device that is capable of sensing deceleration of the vehicle 10. Further, the accelerometer 50 may be in electronic communication with the vehicle lock controller 44. That is, the vehicle lock controller 44 may be operable to send and receive signals to and from the accelerometer 50 to determine the deceleration event.

In addition, the vehicle 10 may further include a sensing device 52, such as a contact sensor, that may be operable to sense or detect contact between the vehicle 10 and the object 16 external to the vehicle 10. The sensing device 52 may include a suitable type of sensor that is capable of sensing contact between the vehicle 10 and the object 16. Further, the sensing device 52 may be in electronic communication with the vehicle lock controller 44. That is, the vehicle lock controller 44 may be operable to send and receive signals to and from the sensing device 52 to determine and/or identify vehicle contact with the object 16.

As shown in FIG. 1, the vehicle 10 may also include a supplementary inflatable restraint 22 configured for deploying to cushion and slow movement of the occupant during and immediately after the deceleration event. For example, the supplementary inflatable restraint 22 may be an air bag configured to inflate on demand once the accelerometer 50 senses the deceleration event and/or the sensing device 52 senses contact between the vehicle 10 and the object 16. The supplementary inflatable restraint 22 may generally remain stowed, i.e., undeployed, but may deploy within milliseconds when needed.

Referring again to FIG. 1, the vehicle 10 may further include a sensing diagnostic module 54 or system configured for controlling actuation of the supplementary inflatable restraint 22. That is, the sensing diagnostic module 54 may be disposed in electrical communication with the supplementary inflatable restraint 22 and may include software operable to send a deployment signal to actuate the supplementary inflatable restraint 22 when desired. Further, the sensing diagnostic module 54 may monitor and/or communicate with the accelerometer 50 and sensing device 52 to sense vehicle events that may also necessitate deployment of the supplementary inflatable restraint 22.

The vehicle 10 may also include a body control module 56 configured to control one or more electrical systems or functions of the vehicle 10. For example, the body control module 56 may be an electrical control unit that may include software and one or more controllers operable to control systems or functions of the vehicle 10 such as, but not limited to, exterior lighting for the vehicle 10, the door lock system 38, deployment of the supplementary inflatable restraint 22, seat positioning, washer/wiper actuation, climate settings, mirror positioning, and the like. The body control module 56 may be configured to communicate with other on-board controllers and computers of the vehicle 10 via a central vehicle bus (not shown) and may actuate relays or switches 46 to perform actions in the vehicle 10. As such, during operation of the vehicle 10, the body control module 56 may monitor and/or communicate with the accelerometer 50, the sensing diagnostic module 54, and the like.

Referring now to FIG. 2, the method 12 of locking the plurality of doors of the vehicle 10 is generally described. In particular, the method 12 may include actions for controlling the vehicle 10 and, more specifically, for controlling the door lock system 38 of the vehicle 10. However, it is to be appreciated that the order of operation of the method 12 is not limited to the sequential execution as illustrated in FIG. 2, but may be performed in one or more varying orders, or simultaneously, as applicable in accordance with the present disclosure.

The method 12 includes sensing 58 the deceleration event with the accelerometer 50 of the vehicle 10 in which the deceleration of the vehicle 10 is greater than or equal to the threshold deceleration. In particular, the method 12 may include continuously monitoring vehicle acceleration and deceleration. Sensing 58 may determine whether the vehicle 10 has or is rapidly changing course, is about to contact the object 16 external to the vehicle 10, and/or is experiencing a sudden braking event. In particular, the accelerometer 50 and/or sensing diagnostic module 54 may sense and/or determine whether the deceleration is equal to or has exceeded the threshold deceleration in a suitable manner. For example, the accelerometer 50 may sense and/or determine the deceleration event based on data received from, e.g., brake sensors, the sensing device 52, and the like. However, it should be appreciated that the accelerometer 50 may also use some other sensor capable of sensing the deceleration of the vehicle 10.

The threshold deceleration may be selected to correspond to a deceleration of the vehicle 10 that is comfortable and secure for the occupant. At a deceleration less than the threshold deceleration, the body control module 56 and/or sensing diagnostic module 54 may take no further action other than continued monitoring for the deceleration event. However, at a deceleration greater than or equal to the threshold deceleration, at least one of the accelerometer 50 and the sensing device 52 may send a signal to the sensing diagnostic module 54 to initiate deployment of the supplementary inflatable restraint 22.

That is, the method 12 may also include sensing 58 contact between the vehicle 10 and the object 16 external to the vehicle 10 with the sensing device 52 of the vehicle 10. Such sensing 58 may determine whether the vehicle 10 has or is rapidly changing course, has contacted the object 16, and/or is experiencing a sudden braking event. In particular, the sensing device 52 and/or sensing diagnostic module 54 may sense and/or determine whether the vehicle 10 and object 16 have contacted in a suitable manner. For example, the sensing device 52 may sense and/or determine contact based on data received from, e.g., brake sensors, the accelerometer 50, on-board vehicle cameras (not shown), and the like. However, it should be appreciated that sensing 58 may include using some other sensor capable of sensing contact between the vehicle 10 and the object 16.

As described with continued reference to FIG. 2, the method 12 also includes, after sensing 58, deploying 20 the supplementary inflatable restraint 22 of the vehicle 10. That is, deploying 20 may include inflating the supplementary inflatable restraint 22. In particular, deploying 20 may include sending the signal from at least one of the accelerometer 50 and the sensing device 52 to the sensing diagnostic module 54 disposed in electrical communication with the supplementary inflatable restraint 22. Further, as set forth in more detail below, deploying 20 may include sending a deployment signal from the sensing diagnostic module 54 to the body control module 56 disposed in electrical communication with the interior door handle 34.

The method 12 also includes, substantially concurrent to deploying 20, locking 18 each of the plurality of doors 14. That is, the method 12 may include ensuring that each vehicle door 14 and the door lock system 38 are disposed in the locked state 40 at the moment the supplemental inflatable restraint 22 is deployed. As used herein, the term substantially concurrent refers to simultaneously deploying 20 and locking 18, i.e., the doors 14 may lock at exactly the same time as the supplemental inflatable restraint 22 is deployed or the doors 14 may lock milliseconds after the supplemental inflatable restraint 22 is deployed. More specifically, locking 18 may include immediately transitioning each of the plurality of doors 14 from the unlocked state 42 in which actuation of the exterior door handle 36 of the vehicle 10 opens one of the plurality of doors 14, to the locked state 40 in which actuation of the exterior door handle 36 does not open one of the plurality of doors 14. That is, locking 18 may include preventing each of the plurality of doors 14 from transitioning to the unlocked state 42.

In one embodiment, locking 18 may include sending a door lock command from the body control module 56 to the vehicle lock controller 44. That is, locking 18 may include actuating the plurality of door lock actuators 48 each disposed in communication with the respective one of the plurality of doors 14. Stated differently, simultaneous to deploying 20 the supplementary inflatable restraint 22, the body control module 56 may send the door lock command to every one of the plurality of door lock actuators 48 to thereby lock the plurality of doors 14. In other words, upon air bag deployment, the doors 14 of the vehicle 10 may lock.

Therefore, the method 12 may also include ensuring 60 that actuation of the interior door handle 34 of the vehicle 10 does not unlatch a respective one of the plurality of doors 14. That is, the doors 14 may remain locked for a duration, e.g., for from 10 seconds to 20 seconds, or 15 seconds, after the supplementary inflatable restraint 22 is deployed.

As such, the method 12 may include uncoupling 62 an inertia of a door handle 34, 36 of the vehicle 10 from the latch 28 of one of the plurality of doors 14. That is, the method 12 may uncouple intended or unintended actuation of the interior door handle 34 or the exterior door handle 36 for a given door 14 from the latch 28 for that door 14. For example, movement or inertia of the door handle 34, 36 caused by, without limitation, the deceleration event, vehicle deformation, contact with the object 16, contact with the occupant, etc., may not actuate the latch 28 and thus may enhance occupant security and comfort during the deceleration event.

Referring again to FIG. 2, the method 12 may further include, after locking 18, automatically generating 64 a control signal to unlock each of the plurality of doors 14. However, the control signal may be automatically generated after a delay. That is, automatically generating 64 may occur at from 10 seconds to 20 seconds, e.g., at 12 seconds or 14 seconds or 15 seconds or 16 seconds or 18 seconds, after locking 18. Stated differently, the plurality of doors 14 may remain locked for a time after the supplementary inflatable restraint 22 is deployed.

In addition, locking 18 the plurality of doors 14 may occur regardless of whether each of the plurality of doors 14 were previously locked. That is, the doors 14 may be locked or unlocked prior to substantially concurrently deploying 20 and locking 18. As such, the method 12 may include, prior to deploying 20, unlocking 66 at least one of the plurality of doors 14. For example, the occupant may have previously intentionally or unintentionally unlocked one or more of the plurality of doors 14 prior to the deceleration event.

Alternatively, the method 12 may include, prior to deploying 20, locking 18 at least one of the plurality of doors 14. For example, the occupant may have previously intentionally or unintentionally locked on or more of the plurality of doors 14 prior to the deceleration event, such as when a drive gear is selected by the occupant. Therefore, the method 12 ensures that the plurality of doors 14 lock after the supplementary inflatable restraint 22 is deployed, regardless of the current status of the door lock system 38 and/or plurality of doors 14.

Further, many variations and modifications may be made to the herein-described embodiments, the elements of which are to be understood as being among other acceptable examples. Such modifications and variations are intended to be included herein within the scope of this disclosure and protected by the following claims. Moreover, the actions described herein can be performed simultaneously or in an order different from the actions as ordered herein. In addition, the features and attributes of the specific embodiments disclosed herein may be combined in different ways to form additional embodiments which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements, and/or states are required for one or more embodiments or that one or more embodiments necessarily include logic for deciding, with or without author input or prompting, whether these features, elements, and/or states are included or are to be performed in a particular embodiment.

Moreover, the singular forms “a,” “an,” and “the” include plural referents unless the context clearly dictates otherwise. Thus, for example, reference to an item includes reference to one or more items. The term “ones” refers to one, two, or more, and generally applies to the selection a quantity. The term “plurality” refers to two or more of an item. The term “about” or “approximately” means that quantities, dimensions, sizes, formulations, parameters, shapes, and other characteristics need not be exact, but may be approximated and/or larger or smaller, as desired, reflecting acceptable tolerances, conversion factors, rounding off, measurement error, and the like. The term “substantially” means that the recited characteristic, parameter, or value need not be achieved exactly, but that deviations or variations, including for example, tolerances, measurement error, measurement accuracy limitations, and other factors, may occur in amounts that do not preclude the effect the characteristic was intended to provide.

In addition, a plurality of items may be presented in a common list for convenience. However, the list should be construed as though each member of the list is individually identified as a separate and unique member. Thus, no individual member of the list should be construed as a de facto equivalent of other members of the same list solely based on a presentation in a common group without indications to the contrary. Furthermore, where the terms “and” and “or” are used in conjunction with a list of items, they are to be interpreted broadly, in that one or more of the listed items may be used alone or in combination with other listed items. The term “alternatively” refers to selection of one of two or more alternatives, and is not intended to limit the selection to listed alternatives or to one of the listed alternatives at a time, unless the context clearly indicates otherwise.

Further, the processes, methods 12, or algorithms disclosed herein can be deliverable to and/or implemented by a processing device, controller, or computer, which can include an existing programmable electronic control unit or dedicated electronic control unit. Similarly, the processes, methods 12, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods 12, or algorithms can also be implemented in a software executable object. Alternatively, the processes, methods 12, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software, and firmware components. Such example devices may be on-board as part of a vehicle computing system or may be located off-board and conduct remote communication with devices on one or more vehicles 10.

While exemplary embodiments are described above, it is not intended that these embodiments describe every possible form encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages over other embodiments with respect to one or more desired characteristics, one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments with respect to one or more characteristics are not outside the scope of the disclosure and can be desirable for particular applications.

Therefore, the vehicle 10 and method 12 may be useful for enhancing occupant comfort and security during a deceleration event of the vehicle 10. That is, the vehicle 10 and method 12 may ensure that unintended door handle actuations during the deceleration event that are caused by, for example, inertia, vehicle deformation, and vehicle contact with an object 16 external to the vehicle 10 do not cause the plurality of doors 14 to unlatch and/or open. In particular, the method 12 includes locking 18 each of the plurality of doors 14 substantially concurrent to deploying 20 the supplementary inflatable restraint 22 of the vehicle 10. As such, the vehicle 10 and method 12 may ensure that the plurality of doors 14 are locked during and after the deceleration event to thereby maximize occupant security.

While the best modes for carrying out the disclosure have been described in detail, those familiar with the art to which this disclosure relates will recognize various alternative designs and embodiments for practicing the disclosure within the scope of the appended claims.

What is claimed is:

1. A method of locking a plurality of doors of a vehicle, the method comprising:
sensing a deceleration event with an accelerometer of the vehicle in which a deceleration of the vehicle is greater than or equal to a threshold deceleration;
after sensing, deploying a supplementary inflatable restraint of the vehicle; and
substantially concurrent to deploying, locking each of the plurality of doors.

2. The method of claim 1, further including, after locking, automatically generating a control signal to unlock each of the plurality of doors.

3. The method of claim 2, wherein automatically generating occurs at from 10 seconds to 20 seconds after locking.

4. The method of claim 1, further including sensing contact between the vehicle and an object external to the vehicle with a sensing device of the vehicle.

5. The method of claim 1, further including ensuring that actuation of an interior door handle of the vehicle does not unlatch a respective one of the plurality of doors.

6. The method of claim 1, further including uncoupling an inertia of a door handle of the vehicle from a latch of one of the plurality of doors.

7. The method of claim 1, further including, prior to deploying, unlocking at least one of the plurality of doors.

8. The method of claim 1, further including, prior to deploying, locking at least one of the plurality of doors.

9. The method of claim 1, wherein locking includes immediately transitioning each of the plurality of doors from an unlocked state in which actuation of an exterior door handle of the vehicle opens one of the plurality of doors to a locked state in which actuation of the exterior door handle does not open one of the plurality of doors.

10. The method of claim 9, wherein locking includes preventing each of the plurality of doors from transitioning to the unlocked state.

11. The method of claim 4, wherein deploying includes sending a signal from at least one of the accelerometer and the sensing device to a sensing diagnostic module of the vehicle disposed in electrical communication with the supplementary inflatable restraint.

12. The method of claim 11, wherein deploying includes sending a deployment signal from the sensing diagnostic module to a body control module of the vehicle disposed in electrical communication with an interior door handle of the vehicle.

13. The method of claim 12, wherein locking includes sending a door lock command signal from the body control module to a vehicle lock controller.

14. The method of claim 13, wherein locking includes actuating a plurality of door lock actuators each disposed in communication with a respective one of the plurality of doors.

15. A method of locking a plurality of doors of a vehicle, the method comprising:
sensing a deceleration event with an accelerometer of the vehicle in which a deceleration of the vehicle is greater than or equal to a threshold deceleration;
after sensing, deploying a supplementary inflatable restraint of the vehicle;
prior to sensing, unlocking at least one of the plurality of doors;
substantially concurrent to deploying, locking each of the plurality of doors; and
automatically generating a control signal to unlock each of the plurality of doors at from 10 seconds to 20 seconds after deploying.

16. The method of claim 15, wherein locking includes immediately transitioning at least one of the plurality of doors from an unlocked state in which actuation of an exterior door handle of the vehicle opens one of the plurality of doors to a locked state in which actuation of the exterior door handle does not open one of the plurality of doors.

17. The method of claim 16, wherein locking includes preventing each of the plurality of doors from transitioning to the unlocked state.

18. The method of claim 15, further including ensuring that actuation of an interior door handle of the vehicle does not unlatch a respective one of the plurality of doors.

19. The method of claim 18, wherein deploying includes sending a deployment signal from a sensing diagnostic module of the vehicle to a body control module of the vehicle disposed in electrical communication with the interior door handle.

20. The method of claim 19, wherein locking includes sending a door lock command signal from the body control module to a vehicle lock controller.
